(19) United States
(12) Patent Application Publication
(10) Pub. No.: US 2021/0312381 A1
(43) Pub. Date: Oct. 7, 2021

(54) METHOD AND SYSTEM FOR PRESERVING PERISHABLE PRODUCTS DURING MULTI-MODAL TRANSPORTATION

(71) Applicant: Wipro Limited, Bangalore (IN)

(72) Inventors: Manjunath Ramachandra IYER, Bangalore (IN); Chandrashekar Bangalore NAGARAJ, Bangalore (IN); Shashidhar SOPPIN, Bangalore (IN)

(21) Appl. No.: 16/930,681

(22) Filed: Jul. 16, 2020

(30) Foreign Application Priority Data
Apr. 1, 2020 (IN) 202041014524

(51) Int. Cl. G06Q 10/08; G16Y 10/40; G16Y 20/10

(52) U.S. Cl. CPC G06Q 10/0832; G16Y 20/10; G16Y 10/40; G06Q 10/0833

(57) ABSTRACT

A method and a system of preserving perishable products during multi-modal transportation is disclosed. In an embodiment, the method may include configuring environmental parameters for the perishable products during transportation in a vehicle and a first set of control settings for control devices in the vehicle corresponding to the environmental parameters. The first set of control settings that correspond to the environmental parameters is verified using Internet of Things (IoT) sensors in the vehicle. A second set of control settings of the control devices is identified for a deviation in the first set of control settings, and during the multi-modal transportation. The second set of control settings that correspond to the environmental parameters is dynamically enforced thereby preserving the perishable products.

### TECHNICAL FIELD

This disclosure relates generally to transporting perishable products, and more particularly to a method and a system of preserving perishable products during multi-modal transportation.

### BACKGROUND

Perishable products including food items or medical drugs are typically transported from a source, for example a manufacturing unit, to a destination for storage and supply to market. In order to preserve efficacy of the perishable products, proper operating conditions, for example temperature, pressure, humidity, and the like, are to be maintained during transportation. If the operating conditions are not maintained quality of the perishable products are likely to be degraded.

Many challenges are faced during the transportation of the perishable products including improper maintenance of the operating conditions, which is more prominent during multi-modal transportation where the perishable products are transported using multiple vehicles between the source and the destination. Even if the operating conditions are maintained, such maintenance has to be manually performed by driver of vehicle which is not very feasible at all times and proves to be inefficient.

Moreover, there is no maintenance of the perishable products in cases of tampering of sensors (used for maintaining the perishable products) or during emergency conditions including bad weather, road blockage, strike or disaster situations.

### SUMMARY

In one embodiment, a method of preserving perishable products during multi-modal transportation is disclosed. The method includes configuring environmental parameters for the perishable products during transportation in a vehicle and a first set of control settings for control devices in the vehicle corresponding to the environmental parameters. The first set of control settings that correspond to the environmental parameters is verified using Internet of Things (IoT) sensors in the vehicle. A second set of control settings of the control devices is identified for a deviation in the first set of control settings, and during the multi-modal transportation. The second set of control settings that correspond to the environmental parameters is dynamically enforced thereby preserving the perishable products.

In another embodiment, a perishable preservation system for preserving perishable products during multi-modal transportation is disclosed. The perishable preservation system includes a processor and a memory communicatively coupled to the processor, wherein the memory stores the processor instructions, which, on execution, causes the processor to configure environmental parameters for the perishable products during transportation in a vehicle and a first set of control settings for control devices in the vehicle corresponding to the environmental parameters; to verify the first set of control settings that correspond to the environmental parameters using Internet of Things (IoT) sensors in the vehicle; to identify a second set of control settings of the control devices for a deviation in the first set of control settings, and during the multi-modal transportation; and to dynamically enforce the second set of control settings that correspond to the environmental parameters thereby preserving the perishable products.

In yet another embodiment, a non-transitory computer-readable storage medium is disclosed. The non-transitory computer-readable storage medium has stored thereon, a set of computer-executable instructions causing a computer comprising one or more processors to perform steps including configuring environmental parameters for the perishable products during transportation in a vehicle and a first set of control settings for control devices in the vehicle corresponding to the environmental parameters; verifying the first set of control settings that correspond to the environmental parameters using Internet of Things (IoT) sensors in the vehicle; identifying a second set of control settings of the control devices for a deviation in the first set of control settings, and during the multi-modal transportation; and dynamically enforcing the second set of control settings that correspond to the environmental parameters thereby preserving the perishable products.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an environment for preserving perishable products during multi-modal transportation, in accordance with an embodiment.

FIG. 2 is a functional block diagram of a perishable preservation system for preserving perishable products during multi-modal transportation, in accordance with an embodiment.

FIG. 3 is a flowchart of a detailed method of preserving perishable products during multi-modal transportation, in accordance with an embodiment.

FIG. 4 is an exemplary illustration a data reliability test, in accordance with an embodiment.

FIG. 5 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

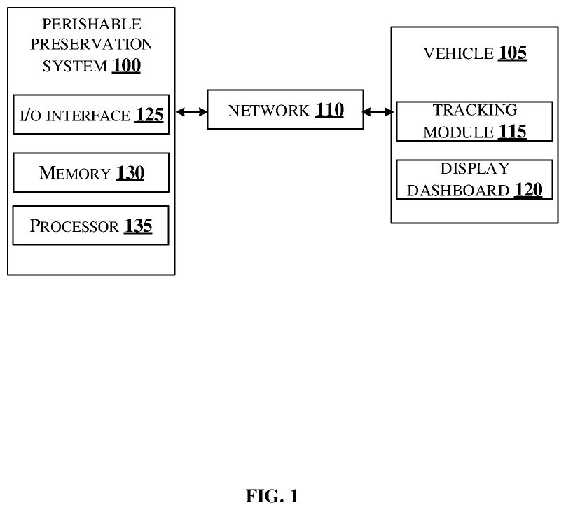

In one embodiment, an environment for preserving perishable products during multi-modal transportation is illustrated in the FIG. 1, in accordance with an embodiment. The environment includes a perishable preservation system 100 and a vehicle 105. The perishable preservation system 100 and the vehicle 105 are connected to each other through a network 110. The network 110 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), General Packet Radio Service (GPRS), and Global System for Mobile Communications (GSM).

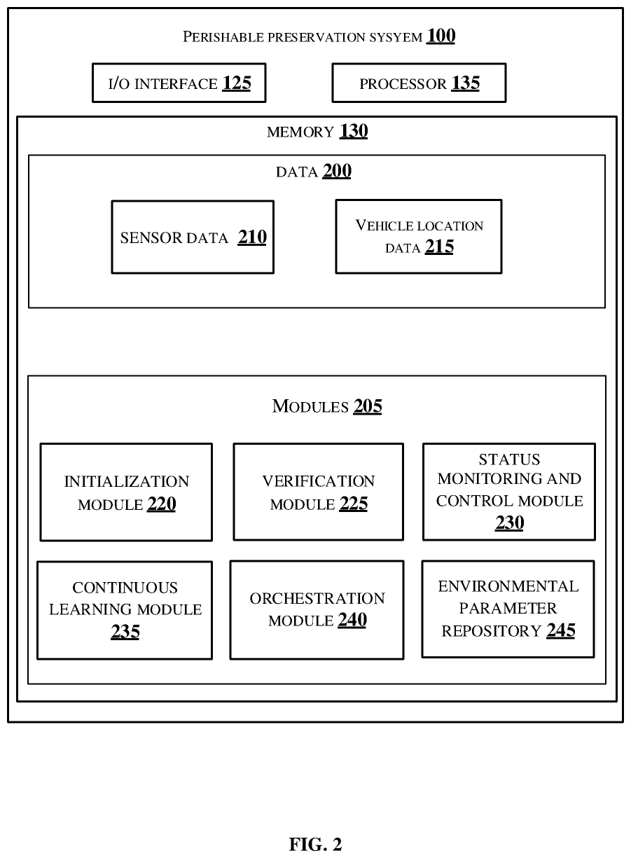

The vehicle 105 includes a tracking module 115 and a display dashboard 120. The tracking module 115 including one or more sensors in the vehicle 105 collects environmental parameters of perishable products being transported in the vehicle 105. The tracking module 115 is explained in detail in conjunction with FIG. 2. The perishable preservation system 100 processes the environmental parameters in order to preserve the perishable products, even during multi-modal transportation. The environmental parameters of perishable products are further displayed on the display dashboard 120 of the vehicle 105.

As will be described in greater detail in conjunction with FIG. 2 to FIG. 4, in order to preserve the perishable products during the multi-modal transportation, the perishable preservation system 100 configures the environmental parameters for the perishable products during transportation in a vehicle and a first set of control settings for control devices in the vehicle corresponding to the environmental parameters. The perishable preservation system 100 verifies the first set of control settings that correspond to the environmental parameters using Internet of Things (IoT) sensors in the vehicle. The perishable preservation system 100 further identifies a second set of control settings of the control devices for a deviation in the first set of control settings, and during the multi-modal transportation. The perishable preservation system 100 determines a second set of control settings of the control devices that correspond to the environmental parameters. Further, the perishable preservation system 100 dynamically enforces the second set of control settings that correspond to the environmental parameters thereby preserving the perishable products.

In order to perform the above discussed functionalities, the perishable preservation system 100 includes an Input/Output (I/O) interface 125, a memory 130 and a processor 135. The memory 130 is communicatively coupled to the processor 135. The memory 130 stores instructions that, when executed by the processor 135, cause the processor 135 to preserve perishable products during multi-modal transportation, as discussed in greater detail in FIG. 2 to FIG. 4. The memory 130 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited to Dynamic Random Access Memory (DRAM), and Static Random-Access memory (SRAM). The memory 130 may also store various data that may be captured, processed, and/or required by the perishable preservation system 100. The I/O interface 125 is coupled with the processor 135 through which an input signal or/and an output signal is communicated.

Referring now to FIG. 2, a functional block diagram of the perishable preservation system 100 for preserving perishable products during multi-modal transportation is illustrated, in accordance with an embodiment. The perishable preservation system 100 includes data 200 and modules 205. In one implementation, the data 200 may be stored within the memory 130. In one example, the data 200 may include sensor data 210 and vehicle location data 215. In one embodiment, the data 200 may be stored in the memory 130 in the form of various data structures. Additionally, the aforementioned data can be organized using data models, such as relational or hierarchical data models. In some embodiments, the data 200 may include other data that may store data, including temporary data, temporary files and predetermined domain specific meta-data, filter conditions, condition separators, transformation operators and functions, generated by the modules 205 for performing the various functions of the perishable preservation system 100.

The modules 205 may include, for example, an initialization module 220, a verification module 225, a status monitoring and control module 230, a continuous learning module 235, an orchestration module 240, and an environmental parameter repository 245. The modules 205 may also comprise other modules to perform various miscellaneous functionalities of the perishable preservation system 100. It will be appreciated that such aforementioned modules may be represented as a single module or a combination of different modules. The modules 205 may be implemented in the form of software, hardware and/or firmware.

In operation, the initialization module 220 receives input parameters from the one or more sensors, the IoT sensors, in the vehicle 105. The input parameters include type of perishable products that include food items and medical drugs, geographical co-ordinates of source and destination of transportation, vehicle route, environmental conditions during the transportation and transitioning of the perishable products between multiple vehicles also referred to as the multi-modal transportation. The initialization module 220 configures environmental parameters of the perishable products during transportation in the vehicle 105. The environmental parameters includes one or more of temperature, pressure, and humidity. A first set of control settings of control devices in the vehicle 105 corresponding to the environmental parameters is also configured. The environmental parameters and the first set of control settings that are configured are provided to the tracking module 225. The environmental parameters and first set of control settings are to be maintained or preserved during the transportation of the perishable products.

In some embodiments, the initialization module 220 also considers time lag during transit of container including the perishable products between multiple vehicles. In some embodiments, the initialization module 220 further identifies the environmental parameters that are to be maintained during the transportation, which are tagged with the geographical locations of the vehicle 105. For example, the initialization module 220 modifies the environmental parameters for a specific time-period before the transition of the container including the perishable products from one vehicle to another. Such modification of the environmental parameters is utilized to cater to unavailability of control devices, for example an air conditioner, a pressure stabilizer, a humidifier, during the transition of the container.

The initialization module 220 also receives control settings from the continuous learning module 235, which is identified based on learning from the previous shipment of the perishable products. In one example, the control settings are identified based on deviation of the first set of control settings, quality of the perishable products at destination, and the like during the transportation.

The verification module 225 verifies the first set of control settings that correspond to the environmental parameters using the IoT sensors in the vehicle, received from the initialization module 220. The verification module 225 receives the environmental parameters, for example temperature, pressure, and humidity, which are to be maintained by the vehicle 105 containing the perishable products during the transportation. The verification is performed by initializing the tracking module 115 located in the vehicle 105.

The tracking module 115 includes the one or more sensors, for example Internet-of-Things (IoT) sensors, installed in the vehicle 105. Some examples of the one or more sensors include, but are not limited to, temperature sensor, pressure sensor, humidity sensor, light sensor and global positioning system (GPS). The tracking module 115 also includes control devices, for example air conditioner, humidifier, light intensity controller, and the like, in the vehicle 105. The tracking module 115 provides a first set of control settings to the control devices and receives the sensor data 210 from the one or more sensors. The tracking module 115 also captures the vehicle location data 215 using the GPS. Along with the sensor data 210, the tracking module 115 also provides radio-frequency identification (RFID) tagging of the vehicle 105 with up-to-date details about the vehicle 105.

The tracking module 115 also receives approved second set of control settings of the control devices from the status monitoring and control module 230 during transportation of the vehicle 105. The approval is received from the orchestration module 240 associated with the transportation of the perishable products.

The verification module 225, using the tracking module 115, further checks that the sensor data 210 has not been tampered or altered or falsified in any way by using secure sensor data generation, configuration changes and the like. In some embodiments, the sensor data 210 is stored in gateways using advanced security methods thus making sure the sensor data 210 is genuine.

In some embodiments, the tracking module 115 is also equipped with the combination of Geographic Information System (GIS) technology and the one or more sensors which enable producers or shippers to connect and be informed about present status of the containers and the perishable products being transported. Such connectivity provides better understanding about any delay in loading, un-loading, problems in port, depots or any issues at production location. The combination of GIS and the one or more sensors helps in data driven insights with error free multi-modal transportation. The combination will easily distinguish when a container is shifted from ship to truck or any other medium.

The status monitoring and control module 230 receives the sensor data 210 from the verification module 225. The status monitoring and control module 230 stores information along with the environmental parameters and displays on the display dashboard 120 of the vehicle 105. The status monitoring and control module 230 identifies a second set of control settings of the control devices for a deviation in the first set of control settings, and during the multi-modal transportation. The status monitoring and control module 230 alerts a driver of the vehicle 105 and the orchestration module 240 in case of the deviation. During such cases, the status monitoring and control module 230 will refer previous data from the continuous learning module 235 for calculating the second set of control settings that correspond to the environmental parameters without any human intervention. The environmental parameters is approved by the orchestration module 240. The tracking module 115 can further set the control devices to the second set of control settings.

The status monitoring and control module 230 implements the advanced security methods for transmitting the second set of control settings to the orchestration module 240 for approval. The status monitoring and control module 230 receives inputs from the orchestration module 240 to perform any major change or action. The status monitoring and control module 230 also stores approved adjustments to the environmental parameter repository 245 so that it can be utilized in future transportation purposes. In some embodiments, if approval is not received for certain period of time, the second set of control settings are approved automatically (after proper verification using a Merkle tree data reliability test and relayed to the control devices).

The status monitoring and control module 230 also tracks personnel parameters, for example personnel performance for maintaining time efficiency, deviation of actual route from pre-set route, vehicle speed, and the like. The status monitoring and control module 230 stores these parameters to the environmental parameter repository 245 to evaluate the personnel performance. Such parameters can be compared with expected parameters and based on the comparison reward points are updated.

The continuous learning module 235 performs learning of the environmental parameters, deviation in the first set of control settings, locations of the vehicle, the first set of control settings of the control devices, the second set of control settings of the control devices, and personnel parameters. In some embodiments, a Recursive Learning (RL) based model is used for the learning.

The orchestration module 240 monitors data received from the status monitoring and control module 230 of the vehicle 105. The data is related to the deviation in the first set of control settings, and during the multi-modal transportation. The orchestration module 240 also receives data related to the second set of control settings of the control devices. The orchestration module 240 also considers multi-modal and multi-hop transportation related parameters including distance or time for next transitioning of vehicles, average transitioning time, environmental conditions of transitioning location, and the like, for identifying the second set of control settings of the control devices. Further, geographical locations of the vehicle where the deviation starts, remaining time of journey, weather conditions of upcoming journey locations, and the like are also considered to approve the second set of control settings. The orchestration module 240 further identifies and takes appropriate decisions dynamically for re-planning, re-routing, suggestive or corrective methods and decisions in driving the perishable preservation system 100 automatically without any intervention.

The environmental parameter repository 245 stores all environmental parameters and the control settings across the transportation (multi-modal and multi-hop transport) together with the vehicle location data 215. The environmental parameter repository 245 also aggregates the reward points based on various parameters and closeness of expected values dynamically and automatically. The reward points allocated to the vehicle 105 is updated for preserving the perishable products during the transportation. In some embodiments, penalty points are awarded.

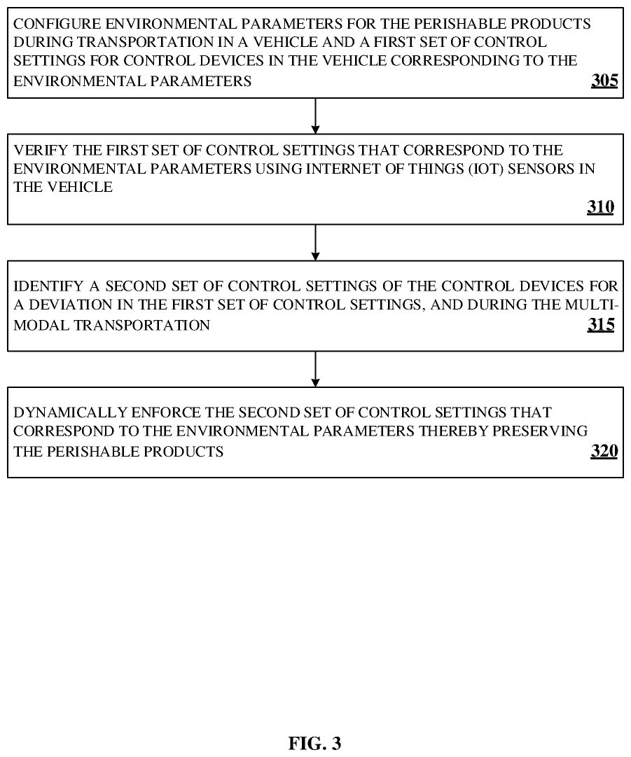

Referring now to FIG. 3, a flowchart of a detailed method of preserving perishable products during multi-modal transportation is illustrated, in accordance with an embodiment.

At step 305, the method includes configuring, by a perishable preservation system, for example the perishable preservation system of FIG. 1, environmental parameters of the perishable products during transportation in a vehicle, for example the vehicle 105. A first set of control settings of control devices in the vehicle corresponding to the environmental parameters is also configured. The environmental parameters of the perishable products include temperature, pressure, humidity and the like, which are required to maintain the perishable products in good condition for expected quality delivery. The environmental parameters are defined based on type of the perishable products and standard operating conditions for preserving the perishable products.

In some embodiments, source and destination locations of the transportation, weather conditions between the source to destination locations, intermediate transitions of the vehicle, expected time delay during transition of the vehicle, weather condition at transition location are considered for setting the environmental parameters of the perishable products during transportation. Previous records based on learning regarding environmental parameters of similar kind of perishable products are also considered for setting the environmental parameters.

At step 310, the method includes verifying, by the perishable preservation system, the first set of control settings that correspond to the environmental parameters using Internet of Things (IoT) sensors in the vehicle. The verification is performed by verifying authenticity and integrity of the first set of control settings using a data reliability test. In some embodiments, the verification is performed to prevent fraudulent control settings, which are received from un-authenticated devices. The sensor data is also verified in order to identify the correct working of one or more IoT sensors in the vehicle.

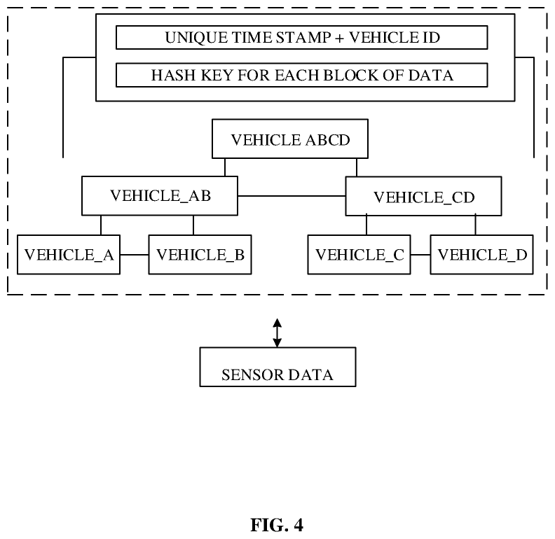

In some embodiments, the data reliability test includes a Merkle tree data reliability test. As illustrated in FIG. 4, four vehicles (namely vehicle_A, vehicle_B, vehicle_C, and vehicle_D) generate one transaction each. Each of these transactions are hashed either using SHA-256 or MD5 based techniques. Considering these hashes as H (A), H(B), H(C), H(D). By design, the Merkle tree data reliability test groups these hashes into pairs for ease of operation. The hashes are paired together as H (AB) and H (CD) and finally to Merkle root as H (ABCD). Such hashing provides integrity and validity of the data. Each vehicle block has the Merkle root contained in the vehicle block header, each time any transaction happens, it is verified that the respective Merkle root for that vehicle block of data is available or not for uniqueness. Thus, the keys are generated as below,

H(A)+H(B)=H(AB) and H(C)+H(D)=H(CD)

Both are hashed to get H (ABCD)

The final Merkle root is Hash ABCD which is combined with the sensor data from respective vehicle and thus make such hash as unique in its nature.

The Merkel tree data reliability test provides both data integrity and validity of data. It significantly reduces amount of memory needed to do above transactions. The Merkel tree data reliability test also verifies transactions in a vehicle block without downloading an entire block, thus saving lot of memory and improving efficiency and robustness.

All real-time control settings of the perishable products from the vehicle are tracked using the one or more sensors, collated and collaborated with respective modules. The sensor data received from similar type of sensors placed at different locations is collated to accurately identify average.

At step 315, the method includes identifying, by the perishable preservation system, a second set of control settings of the control devices for a deviation in the first set of control settings, and during the multi-modal transportation. Previous data based on the learning is used for calculating the second set of control settings of control devices available inside the vehicle. In some embodiments, the environmental parameters that are synchronized and the deviation of the first set of control settings are displayed on display dashboard of the vehicle.

In some embodiments, control settings comparison and analysis is performed using different methods. For example, a Mean/Median/Mode of all values and how much actual values are near is a method used for sensor based output values including temperature, pressure, humidity, and the like. In another example, a standard deviation of all the values and how much is deviated from normal is a method used for control settings to determine status monitoring and output of control devices including air conditioner, pressure stabilizer, humidifier, and the like. In both methods, historical or previous values are referred to and compared for accuracy and nearness of the values.

At step 320, the method includes dynamically enforcing, by the perishable preservation system, the second set of control settings that correspond to the environmental parameters thereby preserving the perishable products. The objective of this step is to dynamically change the control settings of control devices including air conditioner, pressure stabilizer, humidifier, available inside the vehicle. This dynamic change in operating conditions is performed without any human intervention. In case of the deviation in the first set of control settings, and during the multi-modal transportation, the previous data or the learning is referred to for calculating the second set of control settings. During any sudden interrupt which causes delay in transportation, for example a natural calamity, accident, and the like, the second set of control settings are identified by measuring remaining time to reach the destination or shifting of vehicles. Hence, re-planning is performed during transportation.

The second set of control settings of the control devices and an alternate path or route are further approved. In some embodiments, advanced security methods is implemented to obtain approval such that there is no tampering with the second set of control settings.

If approval is not received for certain period of time, the second set of control settings are approved automatically (after proper verification using the earlier explained Merkle tree data reliability test).

Changes in the control settings of the control devices are continuously tracked till the vehicle reaches the destination.

Further, the method includes performing learning of the environmental parameters, deviation in the first set of control settings, locations of the vehicle, the first set of control settings of the control devices, the second set of control settings of the control devices, and personnel parameters, and where the environmental parameters of the perishable products is configured based on the learning. In some embodiments, a Recursive Learning (RL) based model is used for the learning.

The method further includes updating, by the perishable preservation system, reward points allocated to the vehicle for preserving the perishable products during the transportation. The objective of this method step is to continuously monitor and update all the reward points that are captured and allocate the reward points for maintaining the perishable products. The reward points are allocated to each vehicle based on the closeness of maintaining the perishable products during the transportation and multi-modal transportation. Performance of the personnel including parameters like deviation of actual vehicle location from the required vehicle location, vehicle speed, and the like are also considered for calculating the reward points. For future transportation, vehicle or personnel is allocated for transporting the perishable products based on associated performance and type or criticality of proper maintenance of the perishable products.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

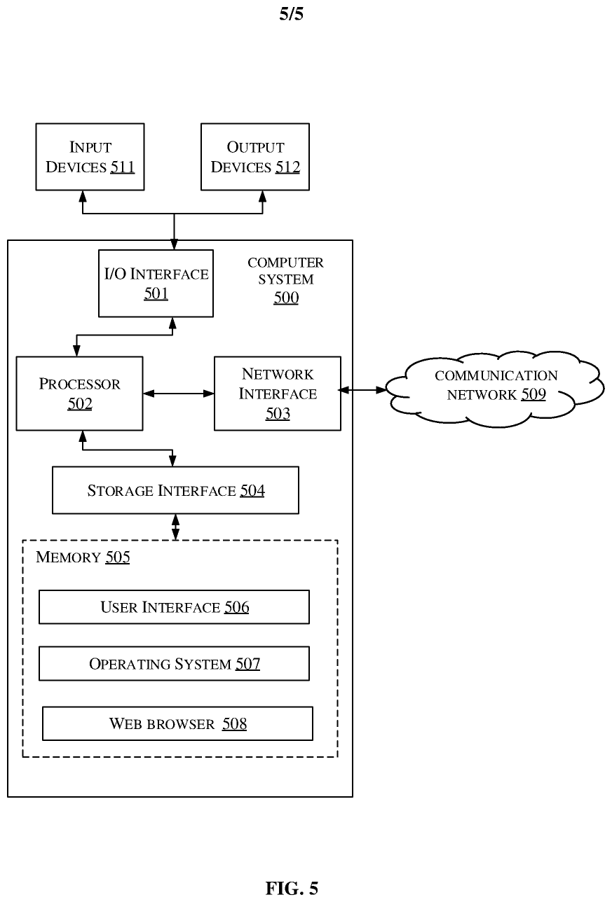

The disclosed methods and systems may be implemented on a conventional or a general-purpose computer system, such as a personal computer (PC) or server computer. Referring now to FIG. 5, a block diagram of an exemplary computer system 502 for implementing various embodiments is illustrated. Computer system 502 may include a central processing unit (“CPU” or “processor”) 504. Processor 504 may include at least one data processor for executing program components for executing user or system-generated requests. A user may include a person, a person using a device such as such as those included in this disclosure, or such a device itself. Processor 504 may include specialized processing units such as integrated system (bus) controllers, memory management control units, floating point units, graphics processing units, digital signal processing units, etc. Processor 504 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 504 may be disposed in communication with one or more input/output (I/O) devices via an I/O interface 506. I/O interface 506 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 506, computer system 502 may communicate with one or more I/O devices. For example, an input device 508 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 510 may be a printer, fax machine, video display (for example, cathode ray tube (CRT), liquid crystal display (LCD), light-emitting diode (LED), plasma, or the like), audio speaker, etc. In some embodiments, a transceiver 512 may be disposed in connection with processor 504. Transceiver 512 may facilitate various types of wireless transmission or reception. For example, transceiver 512 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 504 may be disposed in communication with a communication network 514 via a network interface 516. Network interface 516 may communicate with communication network 514. Network interface 516 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 514 may include, without limitation, a direct interconnection, local area network (LAN), wide area network (WAN), wireless network (for example, using Wireless Application Protocol), the Internet, etc. Using network interface 516 and communication network 514, computer system 502 may communicate with devices 518, 520, and 522. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® e-reader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 502 may itself embody one or more of these devices.

In some embodiments, processor 504 may be disposed in communication with one or more memory devices (for example, RAM 526, ROM 528, etc.) via a storage interface 524. Storage interface 524 may connect to memory 530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 530 may store a collection of program or database components, including, without limitation, an operating system 532, user interface 534, web browser 536, mail server 538, mail client 540, user/application data 542 (for example, any data variables or data records discussed in this disclosure), etc. Operating system 532 may facilitate resource management and operation of computer system 502. Examples of operating systems 532 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 534 may facilitate display, execution, interaction, manipulation, or operation of program components through textual or graphical facilities. For example, user interfaces may provide computer interaction interface elements on a display system operatively connected to computer system 502, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 502 may implement a web browser 536 stored program component. Web browser 536 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 502 may implement a mail server 538 stored program component. Mail server 538 may be an Internet mail server such as MICROSOFT® EXCHANGE® mail server, or the like. Mail server 538 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 538 may utilize communication protocols such as internet message access protocol (IMAP), messaging application programming interface (MAPI), Microsoft Exchange, post office protocol (POP), simple mail transfer protocol (SMTP), or the like. In some embodiments, computer system 502 may implement a mail client 540 stored program component. Mail client 540 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 502 may store user/application data 542, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above pertain to preserving perishable products during multi-modal transportation without any form of human intervention. The method is adaptive and end-to-end as it can automatically change control settings of control devices inside the vehicle during transportation including during the multi-modal transportation, to meet environmental parameter variations. The disclosure provides security as it involves advanced security methods based approval to handle the data and environment settings. Further, due to low cost the method can be used not only for preserving perishable products but for any other product that requires maintenance during transportation.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of preserving perishable products during multi-modal transportation, the method comprising:
configuring, by a perishable preservation system, environmental parameters for the perishable products during transportation in a vehicle and a first set of control settings for control devices in the vehicle corresponding to the environmental parameters;
verifying, by the perishable preservation system, the first set of control settings that correspond to the environmental parameters using Internet of Things (IoT) sensors in the vehicle;
identifying, by the perishable preservation system, a second set of control settings of the control devices for a deviation in the first set of control settings, and during the multi-modal transportation; and
dynamically enforcing, by the perishable preservation system, the second set of control settings that correspond to the environmental parameters thereby preserving the perishable products.

2. The method as claimed in claim 1 and further comprising:
performing, by the perishable preservation system, learning of the environmental parameters, deviation in the first set of control settings, locations of the vehicle, the first set of control settings of the control devices, the second set of control settings of the control devices, and personnel parameters.

3. The method as claimed in claim 2, wherein the perishable products comprises one or more of food items and medical drugs.

4. The method as claimed in claim 2, wherein the environmental parameters comprises one or more of temperature, pressure, and humidity.

5. The method as claimed in claim 2, wherein the environmental parameters are defined based on type of the perishable products and standard operating conditions for preserving the perishable products.

6. The method as claimed in claim 2, wherein the environmental parameters of the perishable products is configured based on the learning.

7. The method as claimed in claim 1 and further comprising:
updating, by the perishable preservation system, reward points allocated to the vehicle for preserving the perishable products during the transportation.

8. The method as claimed in claim 1, wherein verifying the first set of control settings comprises:
verifying authenticity and integrity of the first set of control settings using a data reliability test, wherein the data reliability test comprises a Merkle tree data reliability test.

9. A perishable preservation system for preserving perishable products during multi-modal transportation, the perishable preservation system comprising:
a processor; and
a memory communicatively coupled to the processor, wherein the memory stores the processor instructions, which, on execution, causes the processor to:
configure environmental parameters for the perishable products during transportation in a vehicle and a first set of control settings for control devices in the vehicle corresponding to the environmental parameters;
verify the first set of control settings that correspond to the environmental parameters using Internet of Things (IoT) sensors in the vehicle;
identify a second set of control settings of the control devices for a deviation in the first set of control settings, and during the multi-modal transportation; and
dynamically enforce the second set of control settings that correspond to the environmental parameters thereby preserving the perishable products.

10. The perishable preservation system as claimed in claim 9, wherein the processor is configured to:
perform learning of the environmental parameters, deviation in the first set of control settings, locations of the vehicle, the first set of control settings of the control devices, the second set of control settings of the control devices, and personnel parameters.

11. The perishable preservation system as claimed in claim 10, wherein the perishable products comprises one or more of food items and medical drugs.

12. The perishable preservation system as claimed in claim 10, wherein the environmental parameters comprises one or more of temperature, pressure, and humidity.

13. The perishable preservation system as claimed in claim 10, wherein the environmental parameters are defined based on type of the perishable products and standard operating conditions for preserving the perishable products.

14. The perishable preservation system as claimed in claim 10, wherein the environmental parameters of the perishable products is configured based on the learning.

15. The perishable preservation system as claimed in claim 9 and further comprising:
updating reward points allocated to the vehicle for preserving the perishable products during the transportation.

16. The perishable preservation system as claimed in claim 9, wherein the processor is configured to verify the first set of control settings by:
verifying authenticity and integrity of the first set of control settings using a data reliability test, wherein the data reliability test comprises a Merkle tree data reliability test.

17. A non-transitory computer-readable storage medium having stored thereon, a set of computer-executable instructions causing a computer comprising one or more processors to perform steps comprising:
configuring environmental parameters for the perishable products during transportation in a vehicle and a first set of control settings for control devices in the vehicle corresponding to the environmental parameters;
verifying the first set of control settings that correspond to the environmental parameters using Internet of Things (IoT) sensors in the vehicle;
identifying a second set of control settings of the control devices for a deviation in the first set of control settings, and during the multi-modal transportation; and
dynamically enforcing the second set of control settings that correspond to the environmental parameters thereby preserving the perishable products.
